(19) United States
(12) Patent Application Publication
(10) Pub. No.: US 2020/0314297 A1
(43) Pub. Date: Oct. 1, 2020

(54) IMAGING OPTICAL SYSTEM, IMAGE CAPTURE DEVICE, DRIVER/PASSENGER MONITORING SYSTEM, AND MOVING VEHICLE

(71) Applicant: PANASONIC INTELLECTUAL PROPERTY MANAGEMENT CO., LTD., Osaka (JP)

(72) Inventors: Keiichi MATSUZAKI, Kyoto (JP); Michihiro YAMAGATA, Osaka (JP); Norihiro IMAMURA, Osaka (JP)

(73) Assignee: PANASONIC INTELLECTUAL PROPERTY MANAGEMENT CO., LTD., Osaka (JP)

(21) Appl. No.: 16/829,686

(22) Filed: Mar. 25, 2020

(30) Foreign Application Priority Data
Mar. 28, 2019 (JP) 2019-065094

(51) Int. Cl. H04N 5/225; G02B 9/34

(52) U.S. Cl. CPC H04N 5/2252; H04N 5/2254; G02B 9/34

(57) ABSTRACT

An imaging optical system includes a lens system including a first lens, a second lens, a third lens, and a fourth lens, which are arranged in this order such that the first lens is located closest to an object, out of these four lenses and that the fourth lens is located closest to an image formed, out of these four lenses. One surface, facing the object, of the first lens has negative power. The other surface, facing the image, of the first lens has negative power as well.

### CROSS-REFERENCE TO RELATED APPLICATION

This application is based on, and claims the benefit of foreign priority to, Japanese Patent Application No. 2019-065094 filed on Mar. 28, 2019, which is assigned to the assignee of the present application.

### TECHNICAL FIELD

The present disclosure relates to an imaging optical system, an image capture device, a driver/passenger monitoring system, and a moving vehicle.

### BACKGROUND ART

JP 2009-92797 A discloses an imaging lens system. The imaging lens system includes first, second, third, fourth, fifth, and sixth lenses, which are arranged in this order such that the first lens is located closest to an object, the second lens is located second closest to the object, and so on. The imaging lens system is used with an image sensor arranged at its focal point.

The present disclosure provides an imaging optical system, an image capture device, a driver/passenger monitoring system, and a moving vehicle, all of which are configured to reduce the chances of an outer peripheral region, distant from the optical axis, dimming on the image plane.

### SUMMARY

An imaging optical system according to an aspect of the present disclosure includes a lens system including a first lens, a second lens, a third lens, and a fourth lens, which are arranged in this order such that the first lens is located closer to an object than any of the second, third, or fourth lens is and that the fourth lens is located closer to an image formed than any of the first, second, or third lens is. One surface, facing the object, of the first lens has negative power. The other surface, facing the image, of the first lens has negative power as well.

An image capture device according to another aspect of the present disclosure includes: the imaging optical system described above; and an image sensor. The image sensor is configured to receive light condensed by the imaging optical system.

A driver/passenger monitoring system according to still another aspect of the present disclosure includes: the image capture device configured to capture an image of a person who is on board a moving vehicle; and a controller configured to acquire image capturing data from the image capture device.

A moving vehicle according to yet another aspect of the present disclosure includes: a moving vehicle body; and the image capture device mounted on the moving vehicle body.

### BRIEF DESCRIPTION OF DRAWINGS

Preferred embodiments of the present disclosure will now be described in further detail. Other features and advantages of the present disclosure will be better understood with regard to the following detailed description and the accompanying drawings where:

FIG. 1 is a plan view of a moving vehicle according to an exemplary embodiment of the present disclosure;

FIG. 2 is a block diagram of a driver/passenger monitoring system provided for the moving vehicle;

FIG. 3 illustrates an image capture device provided for the moving vehicle;

FIG. 4 is an optical path diagram of the image capture device;

FIG. 5 illustrates a first lens of the image capture device;

FIG. 6 is an aberration diagram showing a spherical aberration according to a first specific example;

FIG. 7 is an aberration diagram showing an astigmatism according to the first specific example;

FIG. 8 is an aberration diagram showing a distortion according to the first specific example;

FIG. 9 is an aberration diagram showing a spherical aberration according to a second specific example;

FIG. 10 is an aberration diagram showing an astigmatism according to the second specific example;

FIG. 11 is an aberration diagram showing a distortion according to the second specific example;

FIG. 12 is an aberration diagram showing a spherical aberration according to a third specific example;

FIG. 13 is an aberration diagram showing an astigmatism according to the third specific example;

FIG. 14 is an aberration diagram showing a distortion according to the third specific example;

FIG. 15 is an aberration diagram showing a spherical aberration according to a fourth specific example;

FIG. 16 is an aberration diagram showing an astigmatism according to the fourth specific example;

FIG. 17 is an aberration diagram showing a distortion according to the fourth specific example;

FIG. 18 is an aberration diagram showing a spherical aberration according to a fifth specific example;

FIG. 19 is an aberration diagram showing an astigmatism according to the fifth specific example;

FIG. 20 is an aberration diagram showing a distortion according to the fifth specific example;

FIG. 21 is an aberration diagram showing a spherical aberration according to a sixth specific example;

FIG. 22 is an aberration diagram showing an astigmatism according to the sixth specific example; and

FIG. 23 is an aberration diagram showing a distortion according to the sixth specific example.

### DESCRIPTION OF EMBODIMENTS

### (1) Embodiment

An imaging optical system, image capture device, driver/passenger monitoring system, and moving vehicle according to an exemplary embodiment will be described.

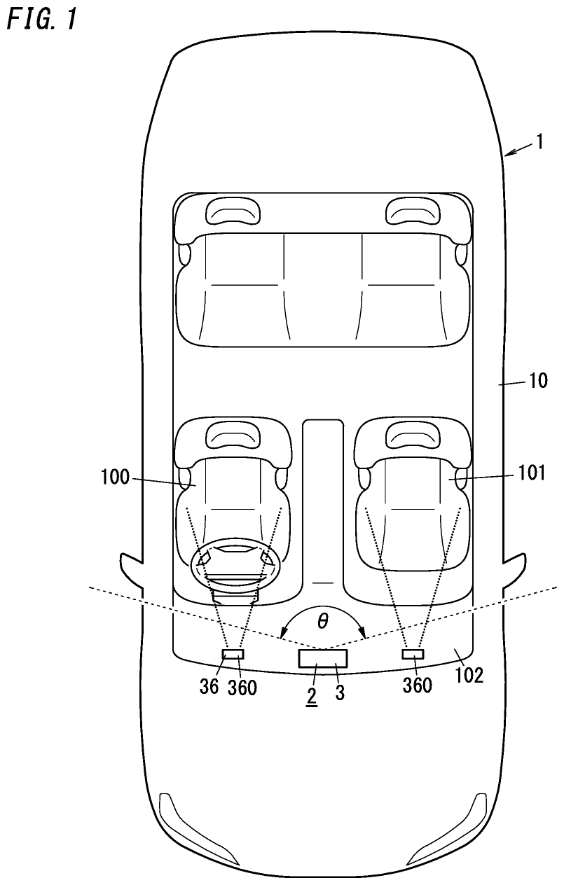

FIG. 1 illustrates a moving vehicle 1 according to an exemplary embodiment. In this embodiment, the moving vehicle 1 is implemented as an automobile. The moving vehicle 1 includes a moving vehicle body 10 and a driver/passenger monitoring system 2. The moving vehicle body 10 is a vehicle body which is able to travel along a road surface. The moving vehicle body 10 forms a major part of the moving vehicle 1. The moving vehicle body 10 includes a driver's seat 100 and an assistant driver's seat 101. The driver's seat 100 and the assistant driver's seat 101 are arranged side by side in the rightward/leftward direction. Even though the moving vehicle 1 is implemented as an automobile in this embodiment, the moving vehicle 1 may also be a bicycle or motorcycle, a railway train, an aircraft, a construction machine, or a ship or boat.

The driver/passenger monitoring system 2 is a system designed to monitor the behavior of at least one person who is on board the moving vehicle 1. The driver/passenger monitoring system 2 is mounted on the moving vehicle body 10. The driver/passenger monitoring system 2 according to this embodiment is configured to monitor the behaviors of a plurality of persons including a driver who is seated in the driver's seat 100 and a passenger who is seated in the assistant driver's seat 101. The persons whose behavior is to be monitored by the driver/passenger monitoring system 2 include not only the driver seated in the driver's seat 100 and the passenger seated in the assistant driver's seat 101 but also two more passengers who are seated side by side in the back seat of the moving vehicle body 10. The number of persons whose behavior is to be monitored by the driver/passenger monitoring system 2 may also be only one, or even three or more.

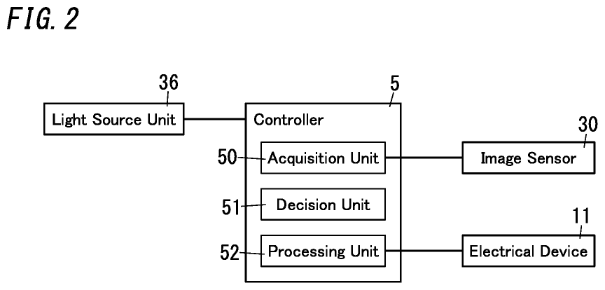

The driver/passenger monitoring system 2 includes an image capture device 3. The image capture device 3 simultaneously captures images of the plurality of persons who are on board the moving vehicle body 10. The moving vehicle 1 further includes electrical devices 11 (see FIG. 2) as equipment for the moving vehicle body 10. Examples of the electrical devices include alarms, electronic seats, electronic door mirrors, and air conditioners.

As shown in FIG. 2, the driver/passenger monitoring system 2 further includes a controller 5. The controller 5 controls the electrical devices 11 based on information collected by the image capture device 3 about the persons on board. Examples of pieces of information about the persons on board include information about any distracted driving, dozing, or positional changes of the persons on board and information about the appearance (such as facial expressions) of the persons on board. Examples of control to be performed by the electrical devices 11 include: sounding an alarm on acquiring information about any distracted driving or dozing of the person on board; automatically bringing the moving vehicle body 10 to an emergency stop on acquiring information about any sudden illness or loss of consciousness of the person on board; and moving the electronic seat, changing the angle of the electronic door mirrors, and controlling the air conditioner according to the facial expression of the persons on board.

The controller 5 may be implemented as one or more processors (microprocessors) and one or more memories, for example. That is to say, the controller 5 performs the function of a control unit by making the one or more processors execute one or more programs stored in one or more memories. The one or more programs may be stored in advance in the memories, downloaded through a telecommunications line such as the Internet, or distributed after having been recorded on a non-transitory storage medium such as a memory card.

The controller 5 includes an acquisition unit 50, a decision unit 51, and a processing unit 52. The acquisition unit 50 acquires image capturing data based on an electrical signal supplied from the image capture device 3. The decision unit 51 makes a decision based on the image capturing data acquired by the acquisition unit 50. The processing unit 52 controls the electrical devices 11 in accordance with the decision made by the decision unit 51. In this embodiment, the acquisition unit 50 acquires moving picture data as the image capturing data. However, this is only an example and should not be construed as limiting. Alternatively, the acquisition unit 50 may also acquire still picture data.

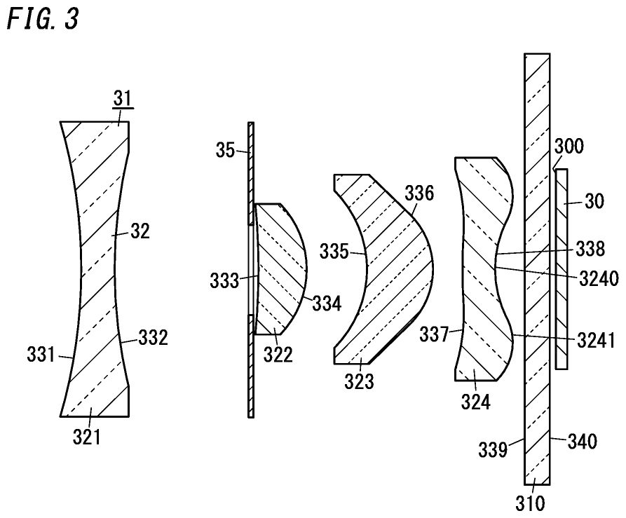

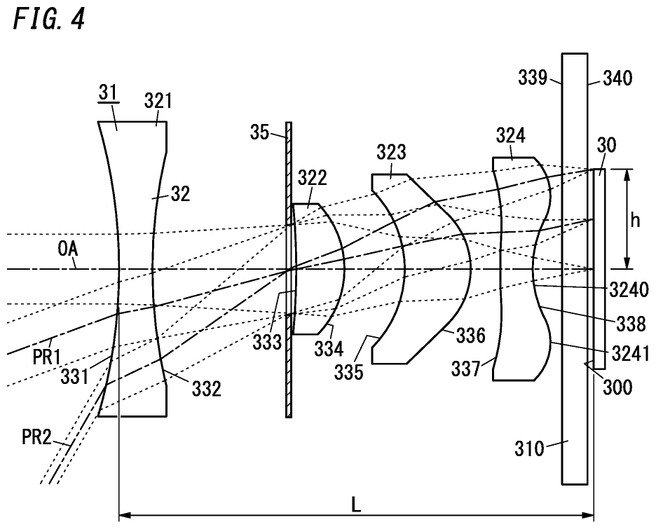

As shown in FIG. 3, the image capture device 3 includes an image sensor 30 and an imaging optical system 31. FIG. 4 is an optical path diagram of the image capture device 3. In FIG. 4, the reference sign OA indicates the optical axis, the reference sign PR1 indicates a principal ray of a light beam incident on the imaging optical system 31 at an angle less than a maximum angle of incidence, and the reference sign PR2 indicates a principal ray of a light beam incident on the imaging optical system 31 at the maximum angle of incidence.

As shown in FIG. 1, the image capture device 3 further includes a light source unit 36. The light source unit 36 irradiates an object as a subject with a light ray falling within the wavelength range to which the image sensor 30 (see FIG. 3) has sensitivity. The light source unit 36 includes a pair of light sources 360. As shown in FIG. 1, the pair of light sources 360 are respectively arranged at a point, facing the driver's seat 100, and at a point, facing the assistant driver's seat 101, in a dashboard 102 of the moving vehicle body 10. Each light source 360 includes a single or a plurality of light source elements. In this embodiment, the light source elements may be implemented as light-emitting diodes that emit an infrared ray. Out of the pair of light sources 360, the light source 360 facing the driver's seat 100 irradiates, with an infrared ray, the driver's seat 100 and the person seated in the driver's seat 100 (i.e., the driver), while the light source 360 facing the assistant driver's seat 101 irradiates, with an infrared ray, the assistant driver's seat 101 and the passenger seated in the assistant driver's seat 101. The infrared ray emitted from the light source unit 36 is reflected from the passenger who is the object, and then condensed by the imaging optical system 31 shown in FIGS. 3 and 4 onto the image sensor 30. The light source elements included in the light source 360 do not have to be light-emitting diodes but may also be light bulbs, electric discharge lamps, or organic electroluminescent elements, as well.

The image sensor (imager) 30 shown in FIG. 4 may be implemented as an infrared image sensor having sensitivity to an infrared ray, and may be a charge coupled device (CCD) or complementary metal-oxide semiconductor (CMOS) image sensor, for example. An image capturing plane 300 of the image sensor 30 is a surface facing the object (or the subject) and is a plane perpendicular to the optical axis OA of the imaging optical system 31. The image capturing plane 300 has a rectangular shape. The image capture device 3 is installed in the moving vehicle body 10 such that the image capturing plane 300 intersects with the forward/backward direction defined for the moving vehicle 1 and the longitudinal axis of the image capturing plane 300 is substantially parallel to the traveling surface on which the moving vehicle 1 travels. The image capturing plane 300 is located at the focal point of the imaging optical system 31. The imaging optical system 31 condenses light rays from the object as a subject to form an image on the image capturing plane 300. The image sensor 30 transforms the image formed on the image capturing plane 300 into an electrical signal based on a great many image capturing pixels.

Note that the image sensor 30 may have sensitivity to only an infrared ray, or have sensitivity to both an infrared ray and other types of light rays, whichever is appropriate. Alternatively, the image sensor 30 may also have sensitivity to only a light ray other than an infrared ray. In that case, a light source unit 36 emitting light falling within a wavelength range, to which the image sensor 30 has sensitivity, is used. Optionally, the light source unit 36 may even be omitted from the image capture device 3.

The imaging optical system 31 includes a lens system 32 and an aperture stop 35. The lens system 32 includes, as single lenses, a first lens 321, a second lens 322, a third lens 323, and a fourth lens 324, which are arranged in this order along the optical axis OA such that the first lens 321 is located closer to the object than any of the second, third, or fourth lens 322, 323, 324 is and that the fourth lens 324 is located closer to the image formed (i.e., the image sensor 30) than any of the first, second, or third lens 321, 322, 323 is. That is to say, the lens system 32 is an optical lens consisting of four lenses, namely, only the first lens 321, the second lens 322, the third lens 323, and the fourth lens 324. Each of the first lens 321, the second lens 322, the third lens 323, and the fourth lens 324 may be a resin lens made of plastic or may also be a glass lens made of glass.

The aperture stop 35 is arranged along the optical axis OA between the first lens 321 and the second lens 322. The aperture stop 35 defines the range of light impinging on the image capturing plane 300 of the image sensor 30.

The first lens 321 is a biconcave lens having negative power. The first lens 321 has a first surface 331 as a surface facing the object and a second surface 332 as a surface facing the image formed. The first surface 331 is an aspheric concave surface having negative power, and the second surface 332 is also an aspheric concave surface having negative power. When the first surface 331 is a concave surface, the angle of incidence of light on the first surface 331 tends to increase, thus increasing the refractive power of the first surface 331, compared to a situation where the first surface 331 is a convex surface. Thus, according to this embodiment, an increase in the number of lenses of the lens system 32 may be reduced. Also, if light is incident on the first surface 331 at a large angle of incidence, the transmittance of the light transmitted through the first surface 331 tends to decrease. However, this embodiment allows the refractive power of the first surface 331 to be increased as described above, thus increasing the density of light rays in an outer peripheral region of the image capturing plane 300, and thereby making the light quantity distribution on the image capturing plane 300 uniform, more easily. In addition, when the second surface 332 is a concave surface, the aberration may be compensated for more appropriately than when the second surface 332 is a convex surface. In this description, the power of a lens surface is defined as follows. Specifically, if a lens surface protrudes outward overall along the optical axis OA, then the lens surface will be hereinafter referred to as a “surface having positive power.” On the other hand, if a lens surface is recessed inward overall along the optical axis OA, then the lens surface will be hereinafter referred to as a “surface having negative power.” Regarding the power of a lens, the power of a lens causing light rays to condense toward the optical axis OA overall will be hereinafter referred to as “positive power,” and the power of a lens causing light rays to diverge away from the optical axis OA overall will be hereinafter referred to as “negative power.”

The second lens 322 is a lens having positive power. The second lens 322 has a third surface 333 as a surface facing the object and a fourth surface 334 as a surface facing the image formed. The third surface 333 is an aspheric concave surface having negative power, and the fourth surface 334 is an aspheric convex surface having positive power.

The third lens 323 is a lens having positive or negative power. The third lens 323 has a fifth surface 335 as a surface facing the object and a sixth surface 336 as a surface facing the image formed. The fifth surface 335 is an aspheric concave surface having negative power, and the sixth surface 336 is an aspheric convex surface having positive power.

The fourth lens 324 is a lens having positive or negative power. The fourth lens 324 has a seventh surface 337 as a surface facing the object and an eighth surface 338 as a surface facing the image formed. The seventh surface 337 is an aspheric concave surface having negative power. The eighth surface 338 has a central region 3240, through which the optical axis OA passes, and an outer peripheral region 3241 surrounding the central region 3240. The central region 3240 is a concave surface having negative power, and the outer peripheral region 3241 is an aspheric convex surface having positive power. On the eighth surface 338, the boundary between the central region 3240 and the outer peripheral region 3241 defines a deflection point.

The imaging optical system 31 further includes a cover 310. The cover 310 is made of glass. A light ray that has passed through the imaging optical system 31 is transmitted through the cover 310 to impinge on the image capturing plane 300. The cover 310 is arranged between the fourth lens 324 and the image sensor 30 in order to protect the image capturing plane 300. The cover 310 has a ninth surface 339 as a surface facing the object and a tenth surface 340 as a surface facing the image formed.

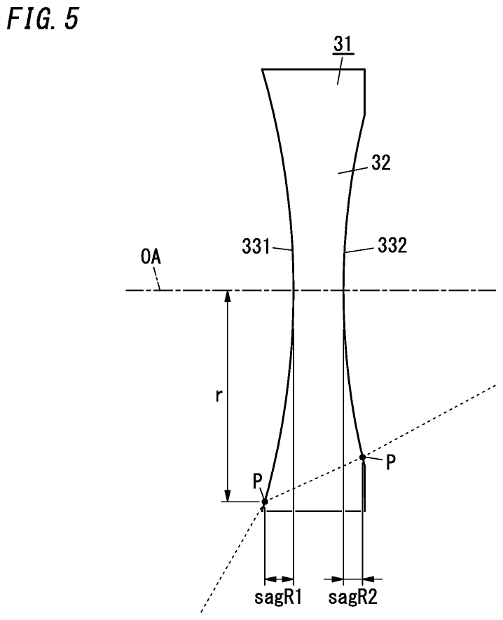

Suppose the focal length of the imaging optical system 31 is indicated by f, the sag at the effective radius of the object-side surface of the first lens 321 is indicated by sagR1, and the sag at the effective radius of the image-side surface of the first lens 321 is indicated by sagR2 as shown in FIG. 5. As used herein, the “sag” refers to an interval, measured in a positive or negative direction along the optical axis OA, between a point P and a reference point. The point P is located at a distance, which is as long as the effective radius r when measured perpendicularly to the optical axis OA, from the optical axis OA. The reference point is either an intersection between the optical axis OA and the first surface 331 or an intersection between the optical axis OA and the second surface 332. In this case, the direction indicated by an arrow pointing toward the object is the positive direction and the direction indicated by an arrow pointing toward the image is the negative direction. Also, the “effective radius r” refers herein to a distance, as measured with respect to either the first surface 331 or the second surface 332, from the optical axis OA to a maximum marginal ray of a light beam passing through the first or second surface 331 or 332.

The imaging optical system 31 suitably satisfies the following Inequalities (1) and (2):

−0.17≤sagR1/f≤−0.02 (1)

0.04≤sagR2/f≤0.2 (2)

Satisfying these Inequalities (1) and (2) reduces the spherical aberration, astigmatism, and distortion of the imaging optical system 31. Note that the imaging optical system 31 does not always have to satisfy these Inequalities (1) and (2).

In addition, the imaging optical system 31 suitably satisfies the following Inequality (3) as well:

sagR2/f≤0.67·sagR1/f+0.022 (3)

Furthermore, the imaging optical system 31 suitably satisfies the following Inequality (4) as well:

sagR2 /f≤0.67·sagR1/f+0.011 (4)

Note that the imaging optical system 31 may satisfy, out of these Inequalities (1)-(4), only Inequalities (1) and (2), or Inequalities (1), (2), and (3), or Inequalities (1), (2), and (4).

Supposing the total optical length of the imaging optical system 31 is indicated by L, the imaging optical system 31 suitably satisfies the following Inequality (5):

L/f≤4.3 (5)

As used herein, the total optical length L refers to the distance, as measured along the optical axis OA, from the first surface 331 to the image capturing plane 300.

According to this embodiment, satisfying this Inequality (5) reduces an increase in the overall size of the imaging optical system 31. Note that the imaging optical system 31 does not always have to satisfy the Inequality (5).

Also, the angle of view θ of the image capture device 3 is suitably equal to or greater than 100 degrees. As used herein, the “angle of view θ” refers herein to a diagonal angle of view. According to this embodiment, setting the angle of view of the image capture device 3 at an angle equal to or greater than 100 degrees in this manner allows the image capture device 3 to capture, when used as a part of a driver/passenger monitoring system 2 for the moving vehicle 1, images of a plurality of persons on board simultaneously.

Furthermore, the angle of view θ of the image capture device 3 is suitably equal to or less than 150 degrees. This may reduce an increase in the overall size of the imaging optical system 31. Note that the angle of view θ of the imaging optical system may be less than 100 degrees or greater than 150 degrees.

Supposing the image height (i.e., the radius of the image circle) of the imaging optical system 31 is identified by h, the image capture device 3 suitably satisfies the following Inequality (6):

h<f·sin θ (6)

According to this embodiment, satisfying this Inequality (6) reduces an increase in the overall size of the image capture device 3. Note that the image capture device 3 does not always have to satisfy this Inequality (6).

### (2) Specific Examples

Next, specific implementations of the image capture device 3 according to the exemplary embodiment will be described as first through sixth specific examples. The specification data, lens data, the sag values of the first lens 321, and the aspheric coefficients of the image capture device 3 as specific examples are summarized in the following Tables 1-24:

TABLE 1
Example 1: Specification data

| | |
|---|---|
| Focal length | 3.45 mm |
| Effective F value | 2.28 |
| Full angle of view | 120 degrees |
| Maximum image height | 2.4 mm |
| Total optical length | 11.48 mm |
| Designed wavelength | 920 nm-960 nm |

TABLE 2
Example 1: Lens data

| | Radius of | Surface | Refractive | Abbe |
|---|---|---|---|---|
| Surface | curvature | interval | index | number (vd) |
| Object | | 900.000 | | |
| 1^{st} surface | −10.597170 | 0.800 | 1.528288 | 55.9867 |
| 2^{nd} surface | 33.746600 | 3.547 | | |
| Aperture stop | | 0.080 | | |
| 3^{rd} surface | 13.646300 | 1.150 | 1.576921 | 59.5665 |
| 4^{th} surface | −2.689144 | 1.449 | | |
| 5^{th} surface | −2.999601 | 1.580 | 1.528288 | 55.9867 |
| 6^{th} surface | −1.628832 | 0.642 | | |
| 7^{th} surface | 7.317078 | 0.770 | 1.528288 | 55.9867 |
| 8^{th} surface | 1.720344 | 0.757 | | |
| 9^{th} surface | | 0.610 | 1.508373 | 64.0475 |
| 10^{th} surface | | 0.100 | | |
| Image | | | | |

TABLE 3
Example 1: Aspheric coefficient

| | l^{st} surface | 2^{nd} surface | 3^{rd} surface | 4^{th} surface |
|---|---|---|---|---|
| k | 3.029615E−01 | −8.422414E+00 | −6.812247E+01 | 2.000175E+00 |
| A4 | −2.728628E−05 | 7.448072E−04 | −2.834228E−02 | −1.659917E−03 |
| A6 | 1.089141E−05 | 1.853721E−05 | −1.112080E−02 | −1.660770E−03 |
| A8 | 0.000000E+00 | 0.000000E+00 | 8.181864E−03 | 5.145586E−04 |
| A10 | 0.000000E+00 | 0.000000E+00 | −6.722233E−03 | 7.189642E−04 |
| A12 | 0.000000E+00 | 0.000000E+00 | 5.247962E−05 | −2.002653E−04 |
| A14 | 0.000000E+00 | 0.000000E+00 | 3.075670E−04 | −2.107850E−04 |
| A16 | 0.000000E+00 | 0.000000E+00 | −2.506390E−04 | 1.921575E−04 |
| | 5^{th} surface | 6^{th} surface | 7^{th} surface | 8^{th} surface |
| k | 1.024231E+00 | −8.621716E−01 | 3.706885E+00 | −3.768850E+00 |
| A4 | −1.416935E−02 | 8.596953E−03 | −5.408739E−02 | −2.936855E−02 |
| A6 | −5.534107E−03 | −3.740729E−03 | 1.004766E−02 | 2.963764E−03 |
| A8 | 2.242274E−03 | 1.840380E−04 | −3.934276E−04 | −3.685656E−04 |
| A10 | 6.352162E−04 | 1.350513E−04 | −7.295141E−05 | −6.948796E−06 |
| A12 | −8.041100E−05 | −3.110848E−06 | −4.623469E−06 | 2.485640E−06 |
| A14 | 4.739279E−06 | −3.291093E−07 | 3.613266E−07 | −2.999949E−07 |
| A16 | −1.410414E−06 | 4.407357E−09 | 7.775343E−08 | 3.471618E−08 |

TABLE 4
Example 1: First lens sag value

| | Sag | Sag/Focal |
|---|---|---|
| | (mm) | length(mm) |
| 1^{st} surface | −0.56 | −0.162 |
| 2^{nd} surface | 0.17 | 0.049 |

TABLE 5
Example 2: Specification data

| | | |
|---|---|---|
| Focal length | 3.33 | mm |
| Effective F value | 2.06 | |
| Full angle of view | 130 | degrees |
| Maximum image height | 2.4 | mm |
| Total optical length | 11.29 | mm |

| | |
|---|---|
| Designed wavelength | 920 nm-960 nm |

TABLE 6
Example 2: Lens data

| | Radius of | Surface | Refractive | Abbe |
|---|---|---|---|---|
| Surface | curvature | interval | index | number (vd) |
| Object | | 900.000 | | |
| 1^{st} surface | −19.027860 | 0.800 | 1.528288 | 55.9867 |
| 2^{nd} surface | 11.737730 | 3.453 | | |
| Aperture stop | | 0.080 | | |
| 3^{rd} surface | 12.439750 | 1.150 | 1.576921 | 59.5665 |
| 4^{th} surface | −2.665566 | 1.344 | | |
| 5^{th} surface | −3.008653 | 1.580 | 1.528288 | 55.9867 |
| 6^{th} surface | −1.615788 | 0.611 | | |
| 7^{th} surface | 6.414768 | 0.770 | 1.528288 | 55.9867 |
| 8^{th} surface | 1.714286 | 0.796 | | |
| 9^{th} surface | | 0.610 | 1.508373 | 64.0475 |
| 10^{th} surface | | 0.100 | | |
| Image | | | | |

TABLE 7
Example 2: Aspheric coefficient

| | 1^{st} surface | 2^{nd} surface | 3^{rd} surface | 4^{th} surface |
|---|---|---|---|---|
| k | −3.591826E+00 | 1.583231E+01 | −6.925743E+00 | 1.873349E+00 |
| A4 | 1.004525E−04 | 1.005640E−03 | −2.472994E−02 | 1.773621E−03 |
| A6 | 2.928099E−06 | 9.703990E−05 | −9.326256E−03 | −8.598303E−05 |
| A8 | 0.000000E+00 | 0.000000E+00 | 8.779176E−03 | 1.076794E−03 |
| A10 | 0.000000E+00 | 0.000000E+00 | −7.101963E−03 | 8.188930E−04 |
| A12 | 0.000000E+00 | 0.000000E+00 | −2.349741E−04 | −1.474186E−04 |
| A14 | 0.000000E+00 | 0.000000E+00 | 9.743278E−04 | −2.855611E−04 |
| A16 | 0.000000E+00 | 0.000000E+00 | −2.194033E−04 | 1.359350E−04 |
| | 5^{th} surface | 6^{th} surface | 7^{th} surface | 8^{th} surface |
| k | 9.841526E−01 | −8.515451E−01 | 3.969092E+00 | −3.758222E+00 |
| A4 | −1.360080E−02 | 7.828302E−03 | −5.432372E−02 | −2.841441E−02 |
| A6 | −5.663762E−03 | −3.816078E−03 | 1.000499E−02 | 3.043344E−03 |
| A8 | 2.184367E−03 | 1.765702E−04 | −3.621051E−04 | −3.608105E−04 |
| A10 | 6.091830E−04 | 1.341166E−04 | −7.065982E−05 | −6.513587E−06 |
| A12 | −8.729774E−05 | −4.101670E−06 | −4.619451E−06 | 2.590376E−06 |
| A14 | 1.255027E−06 | −5.863622E−07 | 4.252026E−07 | −2.982128E−07 |
| A16 | −2.052047E−06 | 2.588892E−08 | 9.206241E−08 | 3.229517E−08 |

TABLE 8
Example 2. First lens sag value

| | Sag (mm) | Sag/Focal length (mm) |
|---|---|---|
| 1^{st} surface | −0.3 | −0.090 |
| 2^{nd} surface | 0.49 | 0.147 |

TABLE 9
Example 3: Specification data

| | | |
|---|---|---|
| Focal length | 3.26 | mm |
| Effective F value | 2.04 | |
| Full angle of view | 100 | degrees |
| Maximum image height | 2.2 | mm |
| Total optical length | 10.74 | mm |

| | |
|---|---|
| Designed wavelength | 920 nm-960 nm |

TABLE 10
Example 3 Lens data

| | Radius of | Surface | Refractive | Abbe |
|---|---|---|---|---|
| Surface | curvature | interval | index | number (vd) |
| Object | | 900.000 | | |
| 1^{st} surface | −13.542750 | 0.800 | 1.528288 | 55.9867 |
| 2^{nd} surface | 15.256220 | 2.951 | | |
| Aperture stop | | 0.080 | | |
| 3^{rd} surface | 13.020590 | 1.150 | 1.576921 | 59.5665 |
| 4^{th} surface | −2.647120 | 1.325 | | |
| 5^{th} surface | −2.894398 | 1.580 | 1.528288 | 55.9867 |
| 6^{th} surface | −1.549025 | 0.680 | | |
| 7^{th} surface | 5.833110 | 0.770 | 1.528288 | 55.9867 |
| 8^{th} surface | 1.655463 | 0.692 | | |
| 9^{th} surface | | 0.610 | 1.508373 | 64.0475 |
| 10^{th} surface | | 0.100 | | |
| Image | | | | |

TABLE 11
Example 3: Aspheric coefficient

| | 1^{st} surface | 2^{nd} surface | 3^{rd} surface | 4^{th} surface |
|---|---|---|---|---|
| k | −1.873106E+00 | 1.661167E+01 | −1.176391E+01 | 1.873536E+00 |
| A4 | 1.159296E−04 | 7.848102E−04 | −2.574075E−02 | 2.256795E−03 |
| A6 | −3.116223E−05 | 1.688069E−04 | −9.345512E−03 | 7.133057E−05 |
| A8 | 4.980353E−07 | −1.075868E−06 | 8.727821E−03 | 1.108706E−03 |
| A10 | 2.192663E−07 | −2.122198E−06 | −7.322398E−03 | 9.205151E−04 |
| A12 | 1.365950E−08 | −3.261307E−07 | −1.303053E−04 | −1.323878E−04 |
| A14 | −1.680942E−09 | −4.043426E−09 | 5.482510E−04 | −2.752484E−04 |
| A16 | −6.321111E−10 | 1.376134E−08 | 2.299603E−04 | 1.207386E−04 |
| | 5^{th} surface | 6^{th} surface | 7^{th} surface | 8^{th} surface |
| k | 1.005833E+00 | −8.441691E−01 | 3.851413E+00 | −3.276190E+00 |
| A4 | −1.520760E−02 | 7.378297E−03 | −5.494231E−02 | −2.904289E−02 |
| A6 | −5.540555E−03 | −3.721244E−03 | 9.965711E−03 | 3.331815E−03 |
| A8 | 2.361039E−03 | 1.826588E−04 | −3.659062E−04 | −3.497412E−04 |
| A10 | 6.734789E−04 | 1.272545E−04 | −6.510319E−05 | −8.143533E−06 |
| A12 | −7.460979E−05 | −5.723210E−06 | −3.291531E−06 | 2.102838E−06 |
| A14 | 1.060391E−06 | −6.658261E−07 | 4.533102E−07 | −2.939337E−07 |
| A16 | −4.727501E−06 | 1.696153E−07 | 5.139712E−08 | 4.161685E−08 |

TABLE 12
Example 3. First lens sag value

| | Sag (mm) | Sag/Focal length(mm) |
|---|---|---|
| 1^{st} surface | −0.3 | −0.092 |
| 2^{nd} surface | 0.23 | 0.071 |

TABLE 13
Example 4: Specification data

| | | |
|---|---|---|
| Focal length | 3.47 | mm |
| Effective F value | 2.10 | |
| Full angle of view | 130 | degrees |
| Maximum image height | 2.4 | mm |
| Total optical length | 11.27 | mm |

| | |
|---|---|
| Designed wavelength | 920 nm-960 nm |

TABLE 14
Example 4: Lens data

| | Radius of | Surface | Refractive | Abbe |
|---|---|---|---|---|
| Surface | curvature | interval | index | number (vd) |
| Object | | 900.000 | | |
| 1^{st} surface | −30.322620 | 0.800 | 1.528288 | 55.9867 |
| 2^{nd} surface | 10.707840 | 3.541 | | |
| Aperture stop | | 0.080 | | |
| 3^{rd} surface | 12.550110 | 1.150 | 1.576921 | 59.5665 |
| 4^{th} surface | −2.656932 | 1.249 | | |
| 5^{th} surface | −3.040027 | 1.580 | 1.528288 | 55.9867 |
| 6^{th} surface | −1.602864 | 0.542 | | |
| 7^{th} surface | 6.389393 | 0.770 | 1.528288 | 55.9867 |
| 8^{th} surface | 1.682741 | 0.849 | | |
| 9^{th} surface | | 0.610 | 1.508373 | 64.0475 |
| 10^{th} surface | | 0.100 | | |
| Image | | | | |

TABLE 15
Example 4: Aspheric coefficient

| | 1^{st} surface | 2^{nd} surface | 3^{rd} surface | 4^{th} surface |
|---|---|---|---|---|
| k | −5.192653E+01 | 1.577674E+01 | 1.787875E+01 | 1.770966E+00 |
| A4 | 3.306778E−04 | 1.539137E−03 | −2.300026E−02 | 3.986450E−03 |
| A6 | 1.135545E−05 | 2.042129E−04 | −8.082703E−03 | 9.107928E−04 |
| A8 | 0.000000E+00 | 0.000000E+00 | 9.448242E−03 | 1.371370E−03 |
| A10 | 0.000000E+00 | 0.000000E+00 | −6.730923E−03 | 8.750388E−04 |
| A12 | 0.000000E+00 | 0.000000E+00 | 1.110932E−04 | −1.514664E−04 |
| A14 | 0.000000E+00 | 0.000000E+00 | 1.065668E−03 | −3.009836E−04 |
| A16 | 0.000000E+00 | 0.000000E+00 | −1.856263E−04 | 1.303076E−04 |
| | 5^{th} surface | 6^{th} surface | 7^{th} surface | 8^{th} surface |
| k | 9.906285E−01 | −8.368532E−01 | 3.985900E+00 | −3.583823E+00 |
| A4 | −1.369080E−02 | 7.150478E−03 | −5.403688E−02 | −2.835745E−02 |
| A6 | −5.651859E−03 | −3.857664E−03 | 1.003576E−02 | 3.037917E−03 |
| A8 | 2.163541E−03 | 1.716895E−04 | −3.617065E−04 | −3.615466E−04 |
| A10 | 6.050942E−04 | 1.325552E−04 | −7.042556E−05 | −6.722271E−06 |
| A12 | −8.881569E−05 | −3.912598E−06 | −4.582374E−06 | 2.578300E−06 |
| A14 | 5.185588E−07 | −5.272277E−07 | 4.305302E−07 | −2.976513E−07 |
| A16 | −2.621187E−06 | 4.300678E−08 | 9.324956E−08 | 3.360188E−08 |

TABLE 16
Example 4: First lens sag value

| | Sag (mm) | Sag/Focal length(mm) |
|---|---|---|
| 1^{st} surface | −0.1 | −0.029 |
| 2^{nd} surface | 0.63 | 0.182 |

TABLE 17
Example 5: Specification data

| | | |
|---|---|---|
| Focal length | 3.49 | mm |
| Effective F value | 2.20 | |
| Full angle of view | 120 | degrees |
| Maximum image height | 2.4 | mm |
| Total optical length | 11.87 | mm |

| | |
|---|---|
| Designed wavelength | 920 nm-960 nm |

TABLE 18
Example 5: Lens data

| | Radius of | Surface | Refractive | Abbe |
|---|---|---|---|---|
| Surface | curvature | interval | index | number (vd) |
| Object | | 900.000 | | |
| 1^{st} surface | −10.416460 | 0.800 | 1.528288 | 55.9867 |
| 2^{nd} surface | 33.108830 | 3.852 | | |
| Aperture stop | | 0.080 | | |
| 3^{rd} surface | 14.241970 | 1.150 | 1.576921 | 59.5665 |
| 4^{th} surface | −2.678763 | 1.553 | | |
| 5^{th} surface | −2.994860 | 1.580 | 1.528288 | 55.9867 |
| 6^{th} surface | −1.624440 | 0.622 | | |
| 7^{th} surface | 7.420188 | 0.770 | 1.528288 | 55.9867 |
| 8^{th} surface | 1.628477 | 0.751 | | |
| 9^{th} surface | | 0.610 | 1.508373 | 64.0475 |
| 10^{th} surface | | 0.100 | | |
| Image | | | | |

TABLE 19
Example 5: Aspheric coefficient

| | 1^{st} surface | 2^{nd} surface | 3^{rd} surface | 4^{th} surface |
|---|---|---|---|---|
| k | 2.409081E−01 | −4.313531E+01 | −4.969536E+01 | 1.981705E+00 |
| A4 | −2.421728E−05 | 5.938244E−04 | −2.781676E−02 | 1.255223E−04 |
| A6 | 7.793269E−06 | 7.257015E−06 | −1.088475E−02 | −1.706825E−03 |
| A8 | 0.000000E+00 | 0.000000E+00 | 7.984943E−03 | 1.587549E−04 |
| A10 | 0.000000E+00 | 0.000000E+00 | −7.276408E−03 | 5.620576E−04 |
| A12 | 0.000000E+00 | 0.000000E+00 | −5.765487E−04 | −2.179245E−04 |
| A14 | 0.000000E+00 | 0.000000E+00 | −1.074316E−05 | −2.086361E−04 |
| A16 | 0.000000E+00 | 0.000000E+00 | −5.146126E−05 | 2.041407E−04 |
| | 5^{th} surface | 6^{th} surface | 7^{th} surface | 8^{th} surface |
| k | 1.029471E+00 | −8.680078E−01 | 4.007977E+00 | −3.633739E+00 |
| A4 | −1.408345E−02 | 9.017240E−03 | −5.464783E−02 | −2.932430E−02 |
| A6 | −5.648930E−03 | −3.685701E−03 | 1.007392E−02 | 2.966642E−03 |
| A8 | 2.220820E−03 | 1.885382E−04 | −3.839166E−04 | −3.670701E−04 |
| A10 | 6.330523E−04 | 1.342356E−04 | −7.226217E−05 | −6.871851E−06 |
| A12 | −8.067154E−05 | −3.562509E−06 | −4.491117E−06 | 2.561673E−06 |
| A14 | 4.555002E−06 | −4.712170E−07 | 3.671582E−07 | −2.900484E−07 |
| A16 | −1.549543E−06 | −1.366113E−08 | 7.974417E−08 | 3.361891E−08 |

TABLE 20
Example 5: First lens sag value

| | Sag (mm) | Sag/Focal length(mm) |
|---|---|---|
| 1^{st} surface | −0.631 | −0.181 |
| 2^{nd} surface | 0.176 | 0.050 |

TABLE 21
Example 6: Specification data

| | | |
|---|---|---|
| Focal length | 3.45 | mm |
| Effective F value | 2.19 | |
| Full angle of view | 130 | degrees |
| Maximum image height | 2.4 | mm |
| Total optical length | 10.65 | mm |

| | |
|---|---|
| Designed wavelength | 920 nm-960 nm |

TABLE 22
Example 6: Lens data

| | Radius of | Surface | Refractive | Abbe |
|---|---|---|---|---|
| Surface | curvature | interval | index | number (vd) |
| Object | | 900.000 | | |
| 1^{st} surface | −38.401960 | 0.800 | 1.528288 | 55.9867 |
| 2^{nd} surface | 10.946740 | 3.189 | | |
| Aperture stop | | 0.080 | | |
| 3^{rd} surface | 10.878900 | 1.150 | 1.576921 | 59.5665 |
| 4^{th} surface | −2.670211 | 1.044 | | |
| 5^{th} surface | −3.211451 | 1.580 | 1.528288 | 55.9867 |
| 6^{th} surface | −1.625859 | 0.529 | | |
| 7^{th} surface | 6.151718 | 0.770 | 1.528288 | 55.9867 |
| 8^{th} surface | 1.746399 | 0.795 | | |
| 9^{th} surface | | 0.610 | 1.508373 | 64.0475 |
| 10^{th} surface | | 0.100 | | |
| Image | | | | |

TABLE 23
Example 6: Aspheric coefficient

| | 1^{st} surface | 2^{nd} surface | 3^{rd} surface | 4^{th} surface |
|---|---|---|---|---|
| k | −5.580256E+01 | 1.635087E+01 | 5.356740E+01 | 1.664810E+00 |
| A4 | 3.837418E−04 | 7.709053E−04 | −2.246796E−02 | 5.023526E−03 |
| A6 | 1.322512E−05 | 5.155297E−04 | −9.986843E−03 | 1.905874E−03 |
| A8 | 0.000000E+00 | 0.000000E+00 | 7.684528E−03 | 9.059369E−04 |
| A10 | 0.000000E+00 | 0.000000E+00 | −7.137188E−03 | 5.480819E−04 |
| A12 | 0.000000E+00 | 0.000000E+00 | −5.682364E−04 | −1.989367E−04 |
| A14 | 0.000000E+00 | 0.000000E+00 | 1.453424E−03 | −2.886636E−04 |
| A16 | 0.000000E+00 | 0.000000E+00 | 1.869466E−04 | 1.773090E−04 |
| | 5^{th} surface | 6^{th} surface | 7^{th} surface | 8^{th} surface |
| k | 7.556753E−01 | −8.522131E−01 | 3.851680E+00 | −2.315087E+00 |
| A4 | −9.255253E−03 | 7.803381E−03 | −5.318371E−02 | −3.145446E−02 |
| A6 | −6.448415E−03 | −3.747780E−03 | 1.010663E−02 | 2.894755E−03 |
| A8 | 1.948194E−03 | 1.882119E−04 | −3.908309E−04 | −3.511188E−04 |
| A10 | 6.143701E−04 | 1.345294E−04 | −7.622645E−05 | −4.812890E−06 |
| A12 | −9.726179E−05 | −5.500480E−06 | −4.928409E−06 | 2.881255E−06 |
| A14 | 6.081948E−06 | −1.063795E−06 | 4.293472E−07 | −2.987126E−07 |
| A16 | −3.227587E−06 | −5.425104E−08 | 9.415749E−08 | 2.649322E−08 |

TABLE 24
Example 6: First lens sag value

| | Sag (mm) | Sag/Focal length (mm) |
|---|---|---|
| 1^{st} surface | −0.05 | −0.014 |
| 2^{nd} surface | 0.65 | 0.188 |

In Tables 2, 6, 10, 14, 18, and 22, the sign of the radius of curvature is positive when the lens is convex toward the object and is negative when the lens is convex toward the image. Tables 3, 7, 11, 15, 19, and 23 each indicate an aspheric coefficient when the aspheric shape of each of the first through eighth surfaces 331-338 is expressed by the following Equation (7) representing an aspheric surface:

$$Z = \frac{\frac{{H}^{2}}{R}}{1 + \sqrt{1 - ( K + 1 ) \frac{{H}^{2}}{{R}^{2}}}} + {A}_{4} {H}^{4} + {A}_{6} {H}^{6} + {A}_{8} {H}^{8} + {A}_{10} {H}^{10} + {A}_{12} {H}^{12} + {A}_{14} {H}^{14} + {A}_{16} {H}^{16} \qquad ( 7 )$$

where Z indicates an axis extending along the optical axis OA and H indicates the height perpendicular to the optical axis OA.

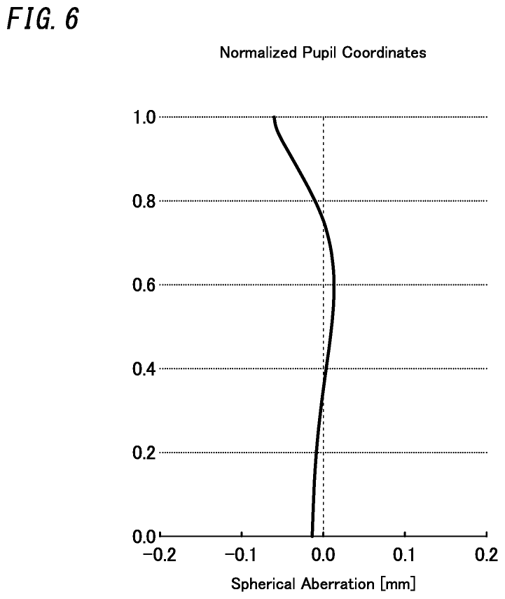

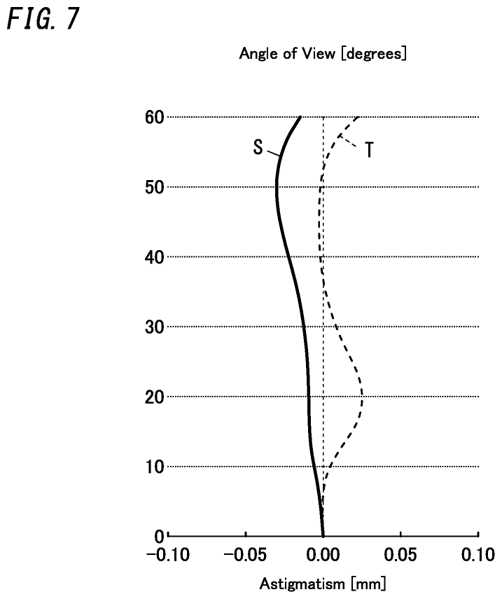

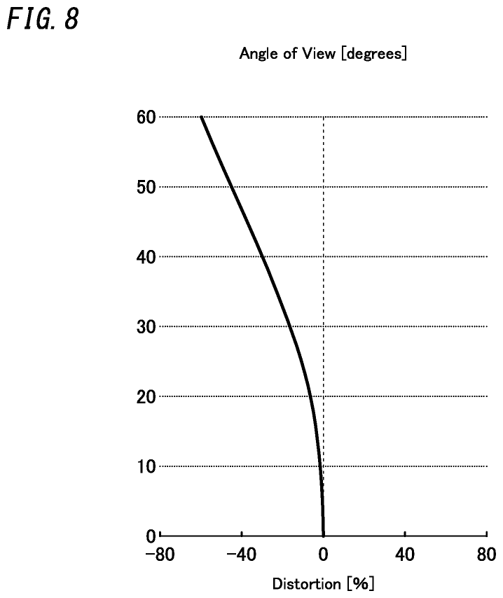

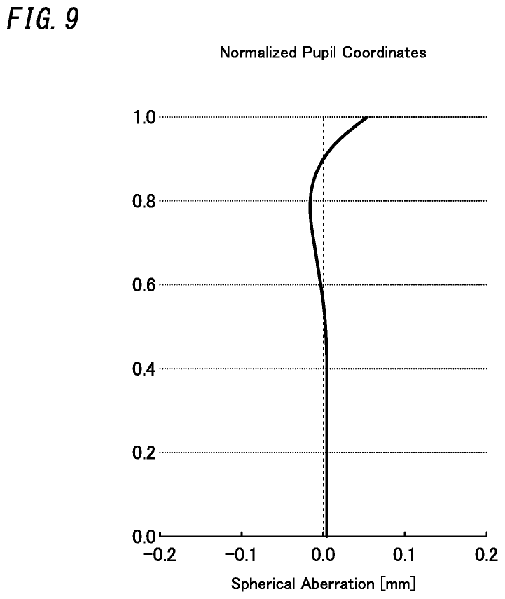

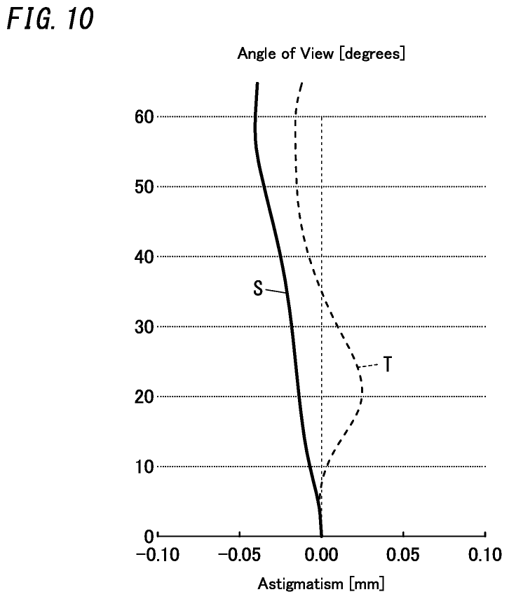

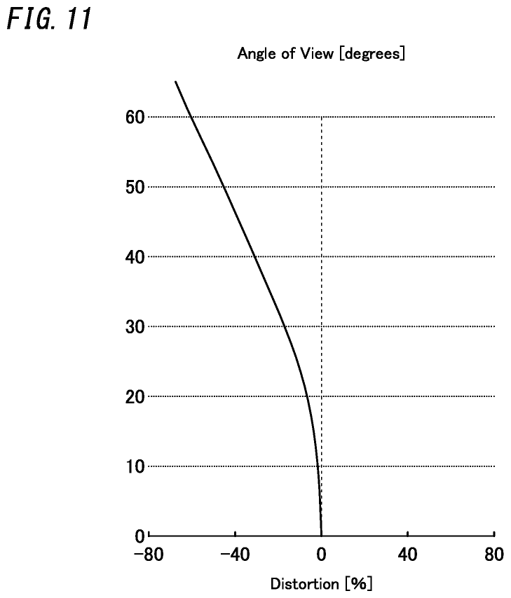

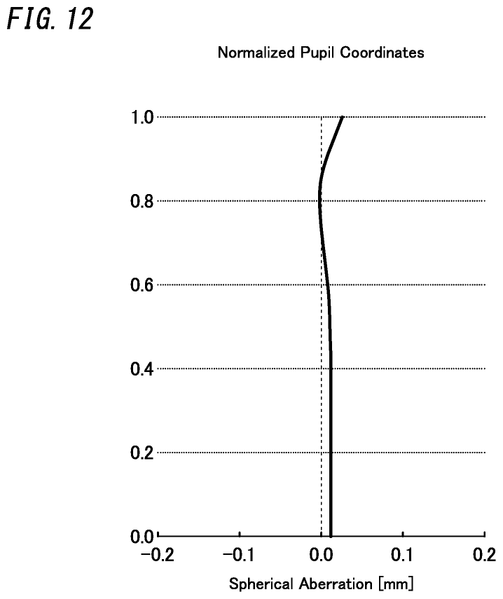

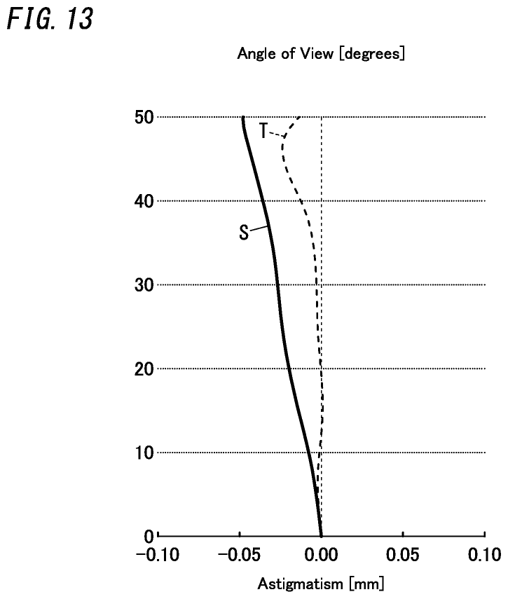

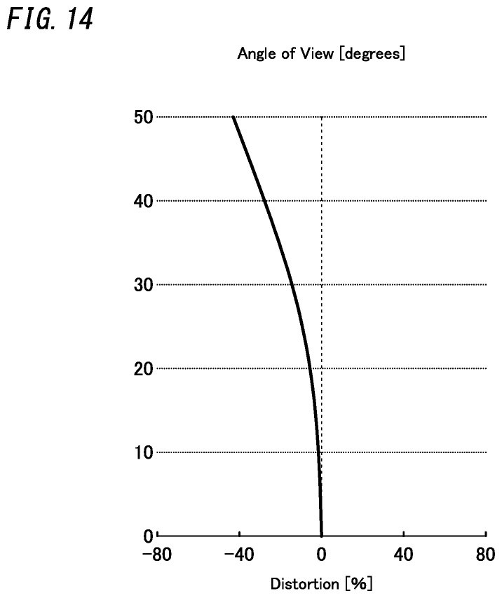

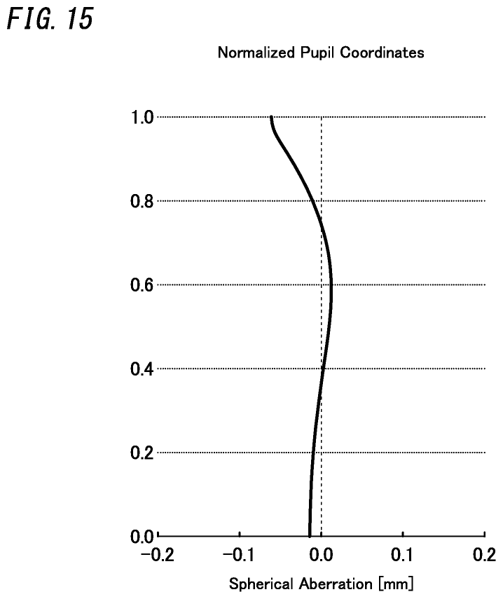

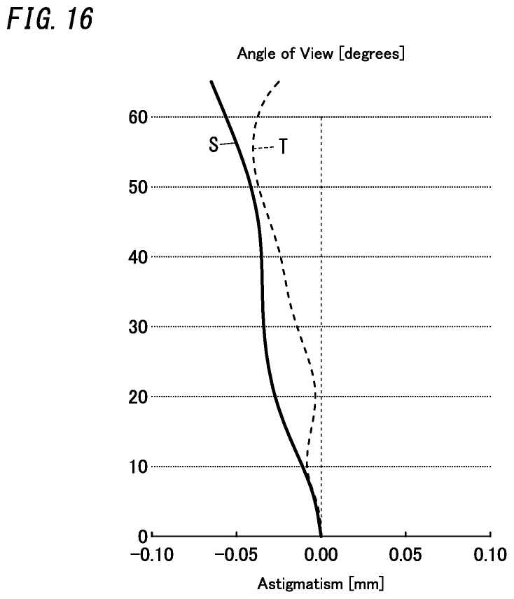

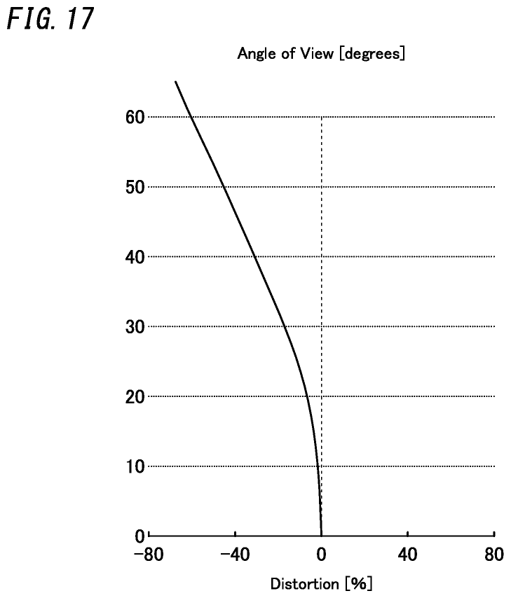

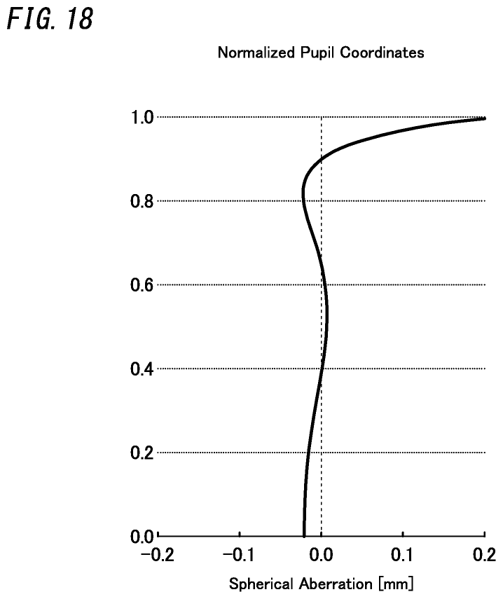

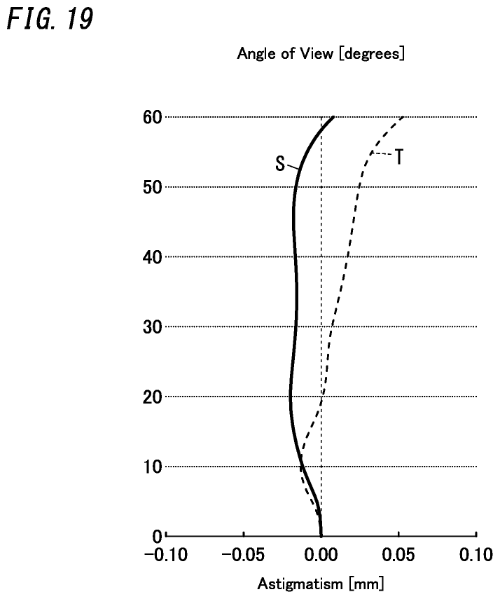

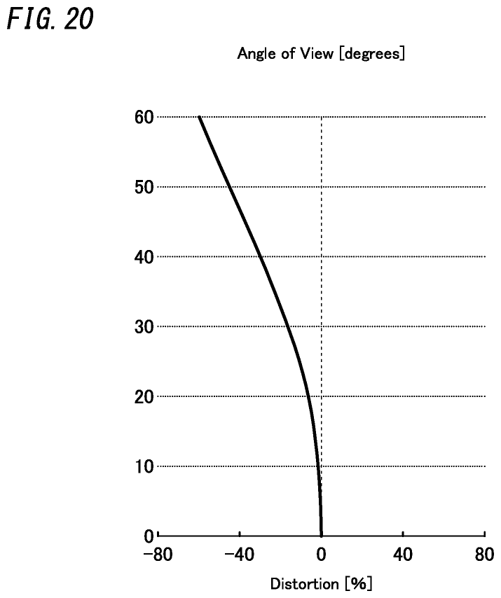

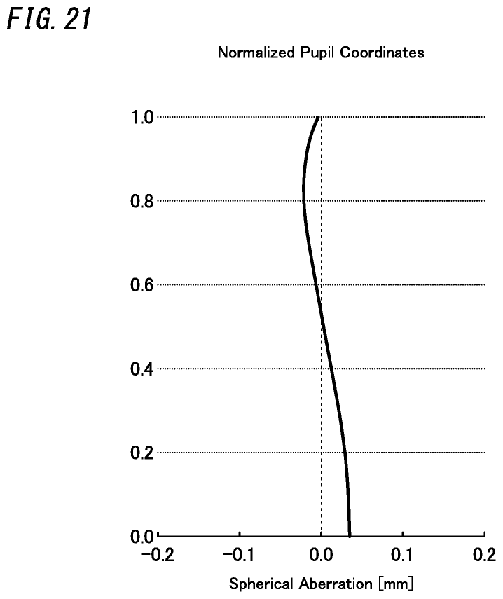

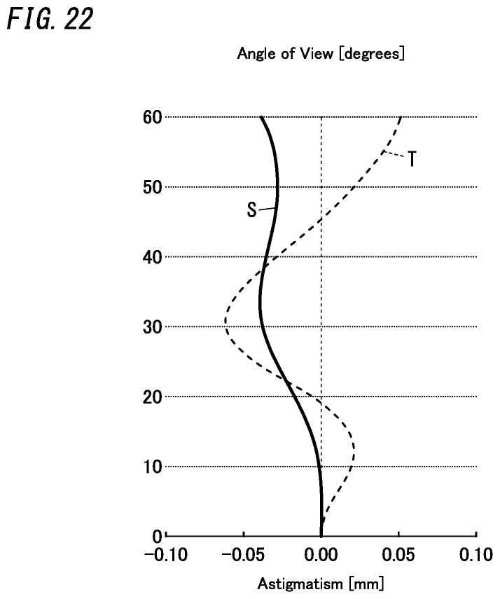

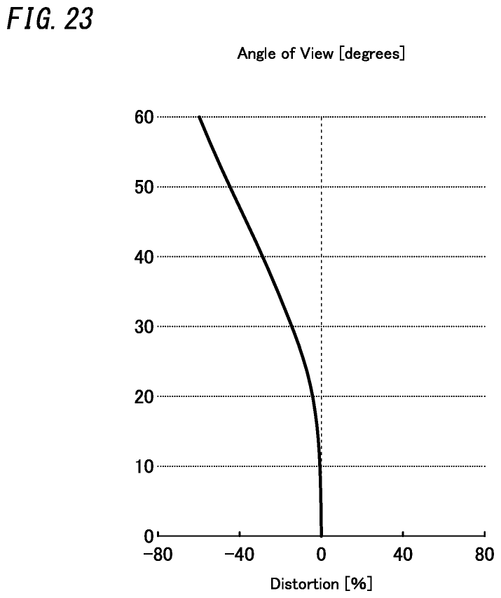

The first through fourth examples each satisfy the Inequalities (1) to (4). On the other hand, the fifth and sixth examples both satisfy the Inequality (1) but do not satisfy any of Inequalities (2) to (4). FIGS. 6-8 are graphs respectively showing the spherical aberration, astigmatism, and distortion of the image capture device 3 according to the first example. FIGS. 9-11 are graphs respectively showing the spherical aberration, astigmatism, and distortion of the image capture device 3 according to the second example. FIGS. 12-14 are graphs respectively showing the spherical aberration, astigmatism, and distortion of the image capture device 3 according to the third example. FIGS. 15-17 are graphs respectively showing the spherical aberration, astigmatism, and distortion of the image capture device 3 according to the fourth example. FIGS. 18-20 are graphs respectively showing the spherical aberration, astigmatism, and distortion of the image capture device 3 according to the fifth example. FIGS. 21-23 are graphs respectively showing the spherical aberration, astigmatism, and distortion of the image capture device 3 according to the sixth example. In FIGS. 7, 10, 13, 16, 19, and 22, the curve S indicates the astigmatism in the sagittal direction and the curve T indicates the astigmatism in the tangential direction.

As can be seen from FIGS. 6-23, although the spherical aberration somewhat increases in the fifth example and the astigmatism somewhat increases in the sixth example, the spherical aberration, the astigmatism, and the distortion are reduced in the first to fourth examples.

### (3) Aspects

As can be seen from the foregoing description of the exemplary embodiment, an imaging optical system (31) according to a first aspect includes a lens system (32). The lens system (32) includes a first lens (321), a second lens (322), a third lens (323), and a fourth lens (324), which are arranged in this order such that the first lens (321) is located closer to an object than any of the second, third, or fourth lens (322, 323, 324) is and that the fourth lens (324) is located closer to an image formed than any of the first, second, or third lens (321, 322, 323) is. One surface, facing the object, of the first lens (321) has negative power. The other surface, facing the image, of the first lens (321) has negative power as well.

According to this aspect, the object-side surface of the first lens (321) has negative power, thus increasing the angle of incidence of light on the object-side surface of the first lens (321), and causing the object-side surface of the first lens (321) to have increased refractive power, compared to a situation where the object-side surface of the first lens (321) has positive power. The first lens (321) having an image-side surface with negative power is able to compensate for aberrations more appropriately than the first lens (321) having an image-side surface with positive power.

An imaging optical system (31) according to a second aspect, which may be implemented in conjunction with the first aspect, has the following additional feature. In the second aspect, the second lens (322) has positive power.

An imaging optical system (31) according to a third aspect, which may be implemented in conjunction with the first or second aspect, has the following additional feature. In the third aspect, one surface, facing the object, of the second lens (322) has negative power, and the other surface, facing the image, of the second lens (322) has positive power.

An imaging optical system (31) according to a fourth aspect, which may be implemented in conjunction with any one of the first to third aspects, has the following additional feature. In the fourth aspect, the second lens (322) has positive power. One surface, facing the image, of the third lens (323) has positive power. A central region (3240) of one surface, facing the image, of the fourth lens (324) has negative power.

This aspect allows the light transmitted through the first lens (321) to be refracted by the second lens (322), the third lens (323), and the fourth lens (324) having such shapes and be imaged on an image-forming plane.

An imaging optical system (31) according to a fifth aspect may be implemented in conjunction with any one of the first to fourth aspects. In the fifth aspect, the first lens (321) is configured as a biconcave lens.

This aspect allows a biconcave lens to be used as the first lens (321).

An imaging optical system (31) according to a sixth aspect, which may be implemented in conjunction with any one of the first to fifth aspects, further includes an aperture stop (35). The aperture stop (35) is arranged between the first lens (321) and the second lens (322).

This aspect allows the aperture stop (35) to define the range of the light impinging on the image sensor (30).

An imaging optical system (31) according to a seventh aspect, which may be implemented in conjunction with any one of the first to sixth aspects, has the following additional feature. Specifically, the imaging optical system (31) according to the seventh aspect satisfies the following Inequalities (1) and (2):

−0.17≤sagR1/f≤−0.02 (1)

0.04≤sagR2/f≤0.2 (2)

where f is a focal length of the imaging optical system (31), sagR1 is a sag at an effective radius of the surface, facing the object, of the first lens (321), and sagR2 is a sag at another effective radius of the surface, facing the image, of the first lens (321).

An imaging optical system (31) according to an eighth aspect, which may be implemented in conjunction with the seventh aspect, satisfies the following Inequality (3):

sagR2/f≤0.67·sagR1/f+0.022 (3).

An imaging optical system (31) according to a ninth aspect, which may be implemented in conjunction with the seventh or eighth aspect, satisfies the following Inequality (4):

sagR2/f≤0.67·sagR1 /f+0.011 (4).

The imaging optical system (31) according to each of the seventh to ninth aspects is able to reduce the spherical aberration, astigmatism, and distortion thereof.

An imaging optical system (31) according to tenth and eleventh aspects, which may be implemented in conjunction with any one of the first to ninth aspects, satisfies the following Inequality (5):

L/f≤4.3 (5)

where f is a focal length of the imaging optical system (31) and L is a total optical length of the imaging optical system (31).

This aspect reduces an increase in the overall size of the imaging optical system (31).

An image capture device (3) according to a twelfth aspect includes: the imaging optical system (31) of any one of the first to eleventh aspects; and an image sensor (30). The image sensor (30) is configured to receive light condensed by the imaging optical system (31).

This aspect provides an image capture device (3) with the imaging optical system (31). In addition, this aspect also reduces an increase in the overall size of the image capture device (3).

An image capture device (3) according to a thirteenth aspect may be implemented in conjunction with the twelfth aspect. The image capture device (3) according to the thirteenth aspect has an angle of view (θ) of 100 degrees or more.

This aspect allows an image to be captured in a wide range using the imaging optical system (31).

An image capture device (3) according to each of fourteenth and fifteenth aspects may be implemented in conjunction with the twelfth or thirteenth aspect. The image capture device (3) according to each of the fourteenth and fifteenth aspects has an angle of view (θ) of 150 degrees or less.

This aspect reduces an increase in the overall size of the imaging optical system (31).

An image capture device (3) according to a sixteenth aspect may be implemented in conjunction with any one of the twelfth to fifteenth aspects. Specifically, the image capture device (3) according to the sixteenth aspect satisfies the following Inequality (6):

h<f·sin θ (6)

where f is a focal length of the imaging optical system (31), θ is an angle of view of the imaging optical system (31), and h is an image height of the imaging optical system (31).

This aspect reduces an increase in the overall size of the image capture device (3).

A driver/passenger monitoring system (2) according to a seventeenth aspect includes: the image capture device (3) of any one of the twelfth to seventeenth aspects configured to capture an image of a person who is on board a moving vehicle (1); and a controller (5) configured to acquire image capturing data from the image capture device (3).

This aspect allows the person who is on board the moving vehicle (1) to be monitored using the image capture device (3).

A moving vehicle (1) according to an eighteenth aspect includes: a moving vehicle body (10); and the image capture device (3) of any one of the twelfth to sixteenth aspects mounted on the moving vehicle body (10).

This aspect provides a moving vehicle (1) with the image capture device (3).

While various embodiments have been described herein above, it is to be appreciated that various changes in form and detail may be made without departing from the spirit and scope of the present disclosure presently or hereafter claimed.

The entire contents of Japanese Patent Application No. 2019-065094 mentioned above are incorporated by reference for all purposes.

1. An imaging optical system comprising a lens system, the lens system including a first lens, a second lens, a third lens, and a fourth lens, the first, second, third, and fourth lenses being arranged in this order such that the first lens is located closer to an object than any of the second, third, or fourth lens is and that the fourth lens is located closer to an image formed than any of the first, second, or third lens is,
one surface, facing the object, of the first lens having negative power, the other surface, facing the image, of the first lens having negative power as well.

2. The imaging optical system of claim 1, wherein
the second lens has positive power.

3. The imaging optical system of claim 1, wherein
one surface, facing the object, of the second lens has negative power, and
the other surface, facing the image, of the second lens has positive power.

4. The imaging optical system of claim 1, wherein
the second lens has positive power,
one surface, facing the image, of the third lens has positive power, and
a central region of one surface, facing the image, of the fourth lens has negative power.

5. The imaging optical system of claim 1, wherein
the first lens is configured as a biconcave lens.

6. The imaging optical system of claim 1, further comprising an aperture stop arranged between the first lens and the second lens.

7. The imaging optical system of claim 1, wherein
the imaging optical system satisfies the following Inequalities (1) and (2):
−0.17≤sagR1/f≤−0.02 (1)
0.04≤sagR2/f≤0.2 (2)
where f is a focal length of the imaging optical system, sagR1 is a sag at an effective radius of the surface, facing the object, of the first lens, and sagR2 is a sag at another effective radius of the surface, facing the image, of the first lens.

8. The imaging optical system of claim 7, wherein
the imaging optical system satisfies the following Inequality (3):
sagR2/f≤0.67·sagR1/f+0.022 (3).

9. The imaging optical system of claim 7, wherein
the imaging optical system satisfies the following Inequality (4):
sagR2/f≤0.67·sagR1/f+0.011 (4).

10. The imaging optical system of claim 1, wherein
the imaging optical system satisfies the following Inequality (5):
L/f≤4.3 (5)
where f is a focal length of the imaging optical system and L is a total optical length of the imaging optical system.

11. The imaging optical system of claim 9, wherein
the imaging optical system satisfies the following Inequality (5):
L/f≤4.3 (5)
where f is a focal length of the imaging optical system and L is a total optical length of the imaging optical system.

12. An image capture device comprising:
the imaging optical system of claim 1; and
an image sensor configured to receive light condensed by the imaging optical system.

13. The image capture device of claim 12, wherein
the image capture device has an angle of view of 100 degrees or more.

14. The image capture device of claim 12, wherein
the image capture device has an angle of view of 150 degrees or less.

15. The image capture device of claim 13, wherein
the image capture device has an angle of view of 150 degrees or less.

16. The image capture device of claim 12, wherein
the image capture device satisfies the following Inequality (6):
h<f·sin θ (6)
where f is a focal length of the imaging optical system, θ is an angle of view of the imaging optical system, and h is an image height of the imaging optical system.

17. A driver/passenger monitoring system comprising:
the image capture device of claim 12 configured to capture an image of a person who is on board a moving vehicle; and
a controller configured to acquire image capturing data from the image capture device.

18. A moving vehicle comprising:
a moving vehicle body; and
the image capture device of claim 12 mounted on the moving vehicle body.
